(19) United States
(12) Patent Application Publication
(10) Pub. No.: US 2009/0053401 A1
(43) Pub. Date: Feb. 26, 2009

(54) Piezoelectric deposition for BAW resonators

(75) Inventors: Sudarsan Uppili, Portland, OR (US); Guillaume Bouche, Beaverton, OR (US); Akhtar Mirfazli, Portland, OR (US); Nicholas S. Argenti, Forest Grove, OR (US)

Correspondence Address: MAXIM/BLAKELY, 1279 OAKMEAD PARKWAY, SUNNYVALE, CA, 94085-4040, US

(73) Assignee: Maxim Integrated Products, Inc.

(21) Appl. No.: 11/895,454

(22) Filed: Aug. 24, 2007

(51) Int. Cl. B05D 5/12

(52) U.S. Cl. 427/100

(57) ABSTRACT

Piezoelectric deposition for BAW resonators wherein a thin amorphous layer of AlN over the bottom electrode before depositing a second layer of AlN over the amorphous layer of AlN, the depositing occurring at a temperature allowing the deposited AlN to self-organize into a desired columnar phase. The bottom electrode may have acoustic isolation thereunder, such as a Bragg mirror. Various details of the fabrication process are disclosed.

### BACKGROUND OF THE INVENTION

1. Field of the Invention

The present invention relates to the field of BAW (bulk acoustic wave) resonators.

2. Prior Art

Piezoelectric resonators are frequently used for signal filtering and reference oscillators. These resonators are commonly referred to as BAW (bulk acoustic wave resonators). Other acronyms for the same or similar devices include FBAR (film bulk acoustic resonators) or SMR (solidly mounted resonators) or TFR (thin film resonators) or SCF (stacked crystal filters).

The resonators must be as efficient as possible in terms of limiting energy losses. These devices are not new and are well documented in the literature.

Standard IC fabrication methods are used for the basic manufacturing sequences, including depositions, photolithography, and etch processes. MEMS techniques may also be employed for packaging and resonator acoustic isolation from the substrate.

A Bragg mirror is used for acoustic isolation in SMR devices. In FBAR, the resonators are built upon a membrane. Both types of isolation are designed to prevent energy loss from the device.

The quality of a filter relies on an efficient piezoelectric transduction. This in turn depends on the quality of the piezoelectric material, usually AlN, deposited as a polycrystalline thin film on the wafer.

People trained in thin film processing know two ways of depositing a film with a controlled texture. One way is to provide an adequate substrate, itself with a well defined crystalline texture and a lattice match to the structure of the film to grow. This is called epitaxial or quasi-epitaxial growth. Another way is, on the opposite, to avoid for the substrate to have any influence on the film deposition: a crystalline phase can be obtained as the natural result of energy (entropy) optimization. This usually involves to prevent thermodynamic obstacles (provide enough energy and time to start with in the process for the film to self-organize as it grows).

### BRIEF DESCRIPTION OF THE DRAWINGS

FIG. 1 is a flow diagram providing an overview of the present invention.

FIG. 2 illustrates the stack resulting from the process of FIG. 1.

FIG. 3 illustrates a BAW substrate with a bottom electrode patterned over an acoustic isolation, namely a Bragg mirror.

FIG. 4 illustrates a stack having a layer of amorphous AlN on the bottom electrode on a Bragg mirror.

### DETAILED DESCRIPTION OF THE PREFERRED EMBODIMENTS

The present invention relates to BAW resonators and filters fabricated using a process that allows an optimum growth of piezoelectric AlN film by means of a seed layer, itself made of AlN, and deposited with sputtering at lower temperature in an amorphous phase. Filters using these resonators can be designed to operate at a wide range of frequencies to address virtually all market filter applications (e.g., GSM, GPS, UMTS, PCS, WLAN, WIMAX, etc.).

Key aspects of a bulk acoustic wave resonator (BAW) are the quality factors (Q) and coupling coefficient k_{eff}2. The Q values are dominated by electrical and acoustic losses. The coupling coefficient is also dependent on both the intrinsic coupling kₜ² of the piezoelectric layer active in the device and the choice and balance of materials used in the stack.

A good coefficient kₜ² for AlN is obtained by controlling the film texture. The desirable AlN is a columnar polycrystalline film typically deposited by PVD. A columnar (0002)-oriented texture is desirable to maximize the film piezoelectric coefficient, or its coupling kₜ². Any misoriented grain will not only decrease the piezoelectric efficiency of the resonator when functioning at its operating frequency, but potentially generates spurious modes that can be triggered by the existence of grains oriented in a direction distinct from the main texture of the film.

To foster an optimum (0002) orientation of the AlN, the film can either be deposited on a well oriented electrode, in the same way a mono-crystal can be grown over a mono-crystalline substrate with matching lattice structure, or in accordance with the present invention, be deposited over a amorphous substrate that would let the AlN self-organize into the desired columnar phase.

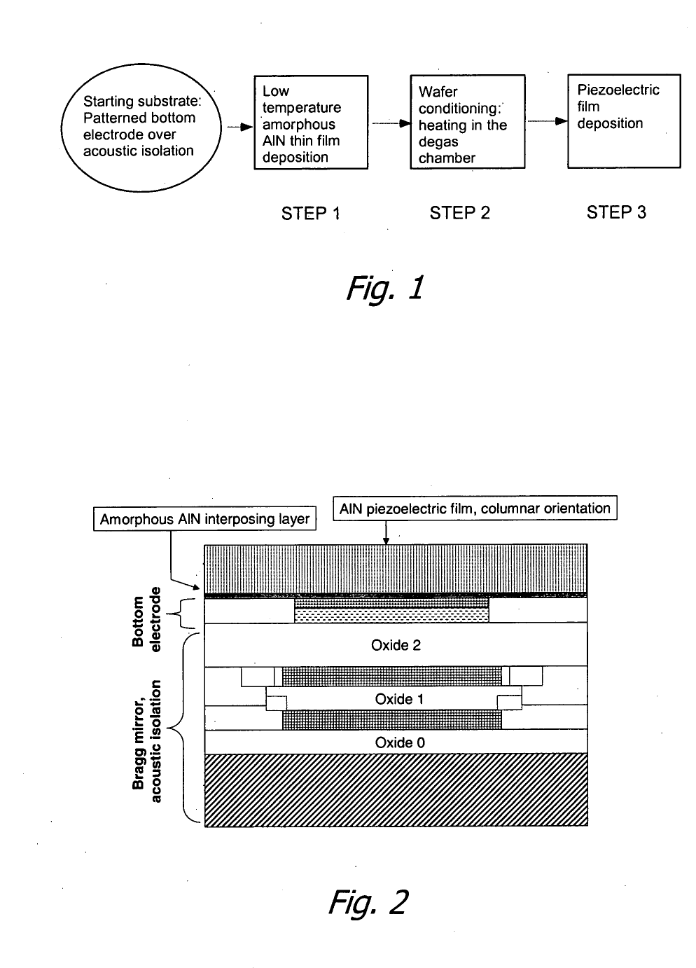

FIG. 1 provides an overview of the present invention. As shown therein, starting with a substrate with a patterned bottom electrode over appropriate acoustic isolation, an amorphous AlN thin film is deposited at low temperature. Then after wafer conditioning, the main piezoelectric film is deposited, such as at a conventional, relatively high temperature, and allowed to self-organize into the desired columnar phase. Once the main piezoelectric film is deposited, completion of the resonator may proceed in accordance with the prior art.

By using the multi-step AlN deposition recipe, a way has been defined to provide a thin amorphous and dielectric AlN interposing layer over the bottom electrode upon which piezoelectric AlN film can grow with the required quality. FIG. 2 illustrates the resulting stack.

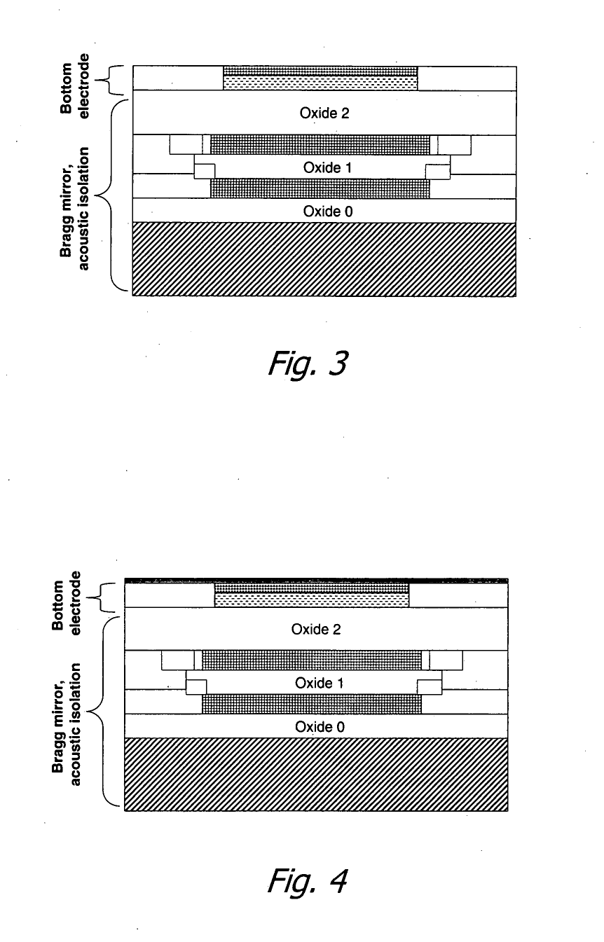

Thus a BAW substrate is provided, consisting of a bottom electrode patterned over an acoustic isolation. In the case presented in FIG. 3, the acoustic isolation is provided by means of a Bragg mirror. The resonator is then called a solidly mounted resonator (SMR). An alternative is to build the resonator over a membrane, the resonator being then called a film bulk acoustic resonator (FBAR).

FIG. 3 illustrates a Bragg mirror consisting of 2.5 bi-layer of alternating films with high acoustic impedance contrast. This Bragg screens the active area of the BAW from the substrate and insures that energy remains in the active area. Over the Bragg mirror, an electrode is deposited and patterned. FIG. 3 shows a planar bottom electrode. This is not necessary to the device but desirable to ease further processing. The electrode can be a polished metal, desirably stiff, like Ru, W or in a lesser measure Mo, or a combination of a still layer and a very conductive layer as Au or Al.

The substrate is then loaded into an AlN PVD deposition tool. Typically, the tool comes as a cluster with several chambers and allows movement of wafers from chamber to chamber without a vacuum break. A usual set-up combines a conditioning chamber (for degas and heating), a PVD deposition chamber for metal film (to process an electrode) and a second reactive PVD chamber to grow the piezoelectric film. Such a cluster is commercially available from companies like Aviza or Unaxis.

The process may be outlined as follows:

1. Deposit a thin (typically in the order of 50 A to 500 A). AlN film at low temperature (typically less than 200° C.). This film is amorphous, as not enough energy is provided to foster a crystalline orientation. Typically the process is a PVD one, with an Al target and a nitrogen rich plasma environment. The resulting stack is shown in FIG. 4.

2. The wafer may be moved to the conditioning chamber in order to heat the wafer to a higher temperature, typically between 200° C. and 500° C.

3. The wafer is again moved either into same chamber as 1 above, or into another chamber from the cluster also suitable for AlN deposition. This time, the process aims at forming a crystalline film over the substrate. With the appropriate heat, enough energy is available for the AlN to self-organize as a polycrystalline textured film in a thermodynamically preferential phase: (0002). The result is illustrated in FIG. 2.

Relevant points on the above include:

1. 1 and 3 above may or may not take place in the same chamber.

2. Amorphous AlN in 1 may or may not be stoichiometric.

3. Amorphous AlN deposited in 1 on a smooth surface provides in turn a smooth surface for crystalline AlN to grow in 3.

4. A vacuum break may or may not occur between 1 and 2.

5. AlN deposited in 1 is preferably as thin as possible to limit performance loss.

6. Well oriented AlN in step 3 can be grown at temperatures as low as 200° C.

7. The nature of the metal constituting the electrode has no influence on the AlN growth.

8. The growth of AlN in a crystalline texture is also the consequence of adequate choice of chamber pressure, power, and other typical parameters familiar to process engineers.

9. 1, 2 or 3 may or may not have to be followed in a row for each wafer. For instance a whole batch of wafers (typically a 25 wafer lot) can be processed through 1, then only individual wafers processed one at a time through 2 and 3.

There are several benefits of this invention:

1. The amorphous AlN film deposited, being dielectric, does not have to be patterned.

2. The amorphous AlN film encapsulates the underlying electrode surface and decouples the electric and acoustic function from the electrode, and the morphological function of the substrate (by opposition to the epi-like AlN growth for which electrode also needs to perform the function of a well oriented substrate). This alleviates difficulty for the whole process integration.

3. No extra chamber is required than the already required conditioning and AlN PVD deposition chamber.

4. Additional process time required for the AlN amorphous interposition layer deposition is short, and happens on potentially the same cluster tool as the piezoelectric deposition itself.

While preferred embodiments of the present invention have been disclosed and described herein for purposes of illustration and not for purposes of limitation, it will be understood by those skilled in the art that various changes in form and detail may be made therein without departing from the spirit and scope of the invention.

What is claimed is:

1. In a method of fabricating a BAW, the improvement comprising:
providing a patterned bottom electrode;
depositing an amorphous layer of AlN over the bottom electrode;
depositing a second layer of AlN over the amorphous layer of AlN, the depositing occurring at a temperature allowing the deposited AlN to self-organize into a desired columnar phase.

2. The method of claim 1 wherein the desired columnar phase of the second layer is 0002 orientation.

3. The method of claim 1 further comprising providing acoustic isolation on a substrate, and wherein the patterned bottom electrode is provided over the acoustic isolation.

4. The method of claim 3 wherein the acoustic isolation is a Bragg mirror.

5. The method of claim 1 wherein the amorphous layer of AlN is approximately 50 A to 500 A thick.

6. The method of claim 1 wherein the amorphous AlN layer is a stoichiometric AlN layer.

7. The method of claim 1 wherein the amorphous AlN layer is not a stoichiometric AlN layer.

8. The method of claim 1 wherein the amorphous AlN layer is deposited by PVD deposition of Al in a nitrogen rich environment.

9. The method of claim 1 wherein the amorphous layer and the second layer of AlN are deposited in the same processing chamber.

10. The method of claim 1 wherein the second layer of AlN is deposited at a temperature in the range of 200° to 500° C.

11. In a method of fabricating a BAW, the improvement comprising:
providing a substrate;
providing a patterned bottom electrode over acoustic isolation on the substrate;
depositing an amorphous layer of AlN over the bottom electrode;
depositing a second layer of AlN over the amorphous layer of AlN, the depositing occurring at a temperature allowing the deposited AlN to self-organize into a 0002 columnar phase orientation.

12. The method of claim 11 wherein the acoustic isolation is a Bragg mirror.

13. The method of claim 11 wherein the amorphous layer of AlN is approximately 50 A to 500 A thick.

14. The method of claim 11 wherein the amorphous AlN layer is a stoichiometric AlN layer.

15. The method of claim 11 wherein the amorphous AlN layer is not a stoichiometric AlN layer.

16. The method of claim 11 wherein the amorphous AlN layer is deposited by PVD deposition of Al in a nitrogen rich environment.

17. The method of claim 11 wherein the amorphous layer and the second layer of AlN are deposited in the same processing chamber.

18. The method of claim 11 wherein the second layer of AlN is deposited at a temperature in the range of 200° to 500° C.

19. In a method of fabricating a BAW, the improvement comprising:
providing a substrate;
providing a patterned bottom electrode over acoustic isolation on the substrate;
depositing an amorphous layer of AlN approximately 50 A to 500 A thick over the bottom electrode by PVD deposition of Al in a nitrogen rich environment;
depositing a second layer of AlN over the amorphous layer of AlN, the depositing occurring at a temperature allowing the deposited AlN to self-organize into a 0002 columnar phase orientation.

20. The method of claim 19 wherein the acoustic isolation is a Bragg mirror.

21. The method of claim 19 wherein the amorphous AlN layer is a stoichiometric AlN layer.

22. The method of claim 19 wherein the amorphous AlN layer is not a stoichiometric AlN layer.

23. The method of claim 19 wherein the amorphous layer and the second layer of AlN are deposited in the same processing chamber.

24. The method of claim 19 wherein the second layer of AlN is deposited at a temperature in the range of 200° to 500° C.
